(19) United States
(12) Patent Application Publication
(10) Pub. No.: US 2026/0031997 A1
(43) Pub. Date: Jan. 29, 2026

(54) Authenticating a User by Matching a Trusted Identification Credential with On-Device Identity Verification in Generating an Authentication Token

(71) Applicant: Google LLC, Mountain View, CA (US)

(72) Inventors: Branden Michael Archer, Mountain View, CA (US); Giles Dominic Hogben, Los Altos Hills, CA (US); David Zeuthen, Bellingham, MA (US); Troy Charles Adrian Kensinger, Austin, TX (US); Nataliya Stanetsky, New York, NY (US); Eugene Liderman, Olney, MD (US)

(73) Assignee: Google LLC, Mountain View, CA (US)

(21) Appl. No.: 19/304,473

(22) Filed: Aug. 19, 2025

Related U.S. Application Data
(60) Provisional application No. 63/864,490, filed on Aug. 15, 2025.

(51) Int. Cl. H04L 9/32

(52) U.S. Cl. CPC H04L 9/3231; H04L 9/3213

(57) ABSTRACT

This document describes systems and techniques for authenticating a user by matching a trusted identification credential with on-device identity verification in generating an authentication token. For example, a request to verify an identity of a current user of the first communications device is received from a second communications device. A trusted identification credential associated with stored biometric information of a designated user is accessed. A sensor of the first communications device is used to collect captured biometric information of the current user. A verification is performed to determine if the captured biometric information matches the stored biometric information. Responsive to determining that the captured biometric information matches the stored biometric information, an authentication token is generated including a cryptographically signed assertion that includes the nonce received from the second communications device and an assertion confirming the match between the captured biometric information and the stored biometric information.

### CROSS-REFERENCE TO RELATED APPLICATION

This application claims the benefit of U.S. Provisional Patent Application Ser. No. 63/864,490 filed on Aug. 15, 2025, the disclosure of which is incorporated by reference herein in its entirety.

### SUMMARY

This document describes systems and techniques for authenticating a user by matching a trusted identification credential with on-device identity verification in generating an authentication token. In response to a request from a second user for authentication, a communications device may collect captured biometric information of a current user of a communications device. If the captured biometric information sufficiently matches stored biometric information of the trusted identification credential associated with a designated user of the communications device, the current user may be authenticated as the designated user of the communications device for participation in secured communications.

For example, a method includes authenticating a user of a first communications device to a second communications device. By a first communications device, a request to verify an identity of a current user of the first communications device is received from the second communications device, the request including a nonce. A trusted identification credential stored on the first communications device is accessed, the trusted identification credential comprising a derived identification credential associated with stored biometric information of a designated user. A sensor of the first communications device is used to collect captured biometric information of the current user. A verification is performed, entirely on the first communications device, to determine if the captured biometric information matches the stored biometric information. In response to determining that the captured biometric information matches the stored biometric information, an authentication token is generated, the authentication token comprising a cryptographically signed assertion that includes the nonce received from the second communications device, the assertion confirming the match between the captured biometric information and the stored biometric information and being signed using a private key associated with the trusted identification credential. The authentication token is transmitted to the second communications device to authenticate the current user as being the designated user.

This Summary is provided to introduce systems and techniques for authenticating a user by matching a trusted identification credential with on-device identity verification in generating an authentication token, as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques for authenticating a user by matching a trusted identification credential with on-device identity verification in generating an authentication token are described in this document with reference to the following Drawings. The same numbers are used throughout the drawings to reference similar features and components.

FIG. 1 is a block diagram of a communications device configured to collect captured biometric information to authenticate a current user as a designated user of the communications device;

FIG. 2 is a schematic diagram of a system in which the communications device of FIG. 1 authenticates the current user to participate in a secured communication with a second user using a second communications device;

FIGS. 3A and 3B are schematic diagrams of government-issued trusted identification credentials and privately-issued identification credentials, respectively, that may be used for authenticating a user with the communications devices of FIGS. 1 and 2;

FIGS. 4A-4C are schematic diagrams of facial recognition being performed to compare captured biometric information and stored biometric information to authenticate a current user;

FIGS. 5A-5D are schematic diagrams of other forms of comparing collected captured biometric information with stored biometric information to authenticate a current user;

FIG. 6 is a schematic diagram of a system in which a communications device interacts with a remote device to authenticate the current user;

FIG. 7 is a block diagram of various forms of communications devices, including a general-purpose computing subsystem to authenticate a current user of the communications device; and

FIG. 8 is a flow diagram of an example method of authenticating a current user as a designated user of a first communications device and communicating that the current user is authenticated to a second communications device.

### DETAILED DESCRIPTION

### Overview

Many types of communications devices, such as mobile telephones and portable or desktop computers, are used for applications ranging from electronic commerce (“e-commerce”) to communications such as text messaging, electronic mail, file exchange, voice communications, or other forms of communication. To maintain security or privacy, some communications may be secured by an exchange of public and/or private keys to verify that participants in these communications are who they purport to be and not an imposter seeking to violate what is intended to be private communications.

A problem with relying on an exchange of keys or other credentials is that these credentials are typically associated with a particular device or sign-on credential for a designated user of the device. If a third party gains access to the device, the third party may access these credentials and pose as the designated user without other participants realizing that their believed-to-be secure communication has been breached. Remote communications that may be performed over a public network may allow people to present themselves under false identities. In other words, in a phrase made popular in Peter Steiner's classic 1993 comic in The New Yorker showing a canine at the keyboard of a computer, “On the Internet, nobody knows you're a dog.”

To allow individuals to verify their identities, trusted identification credentials may be stored in or otherwise made accessible to their communication devices. For example, digital forms of trusted identification credentials such as a driver's license, passport, or employee identification, may be accessed from the communications devices and shown to or transmitted to other parties to demonstrate that the individual is who they purport to be. However, as in the case with keys associated with a device or a device sign-in, a third party who gains access to a communications device may also get access to the trusted identification credential. The third party may then transmit the trusted identification credential to remote users to falsely demonstrate that they are the individual associated with the trusted identification credential. Unlike face-to-face transactions, where the trusted identification credential may be presented for identification, it is not as though a remote user can look at a digital driver's license and glance up to see if the person presenting the digital driver's license matches the photograph included in the digital driver's license.

To address this problem, disclosed systems and techniques may be used for authenticating a user by matching a trusted identification credential via on-device identity verification. Collecting captured biometric information of a current user of a device and comparing it with biometric information associated with the trusted identification credential of a designated user of the communications device allows for verification that the current user of the communications device is the designated user of the device.

For example, a method includes authenticating a user of a first communications device to a second communications device. By a first communications device, a request to verify an identity of a current user of the first communications device is received from the second communications device, the request including a nonce. A trusted identification credential stored on the first communications device is accessed, the trusted identification credential comprising a derived identification credential associated with stored biometric information of a designated user. A sensor of the first communications device is used to collect captured biometric information of the current user. A verification is performed, entirely on the first communications device, to determine if the captured biometric information matches the stored biometric information. In response to determining that the captured biometric information matches the stored biometric information, an authentication token is generated, the authentication token comprising a cryptographically signed assertion that includes the nonce received from the second communications device, the assertion confirming the match between the captured biometric information and the stored biometric information and being signed using a private key associated with the trusted identification credential. The authentication token is transmitted to the second communications device to authenticate the current user as being the designated user.

This document describes systems and techniques for authenticating a user by matching a trusted identification credential with on-device identity verification. Presently, a communications device may be authenticated by verifying that a key associated with the participant is stored in or is otherwise able to be provided by the communications device. However, if a third party gains access to the communications device in which keys are stored, that third party may use that communications device to participate in communications with other parties, deceiving other parties into believing the third party is the key holder. The other parties know that they are engaged with the communications device of an entrusted person, but they have no way of knowing if the entrusted person is the person using the device.

Implementations of the disclosed technology are designed with user privacy as a central consideration. The biometric information collected (e.g., captured biometric information 120) and stored (e.g., stored biometric information 116) is highly sensitive personal information. Accordingly, such data can be handled using privacy-enhancing techniques. For example, the data may be stored in an encrypted format within a secure element or trusted execution environment on the communications device 100 or a remote server. All data transmissions over a network can be protected using end-to-end encryption. Users may be provided with clear notice and must provide explicit consent before their biometric information is collected, stored, or used for authentication, and they may be given control to manage or delete their stored data. In some implementations, rather than storing raw biometric information, the system may store a template, hash, or other mathematical representation of the biometric information that is sufficient for matching but cannot be reverse-engineered to recreate the original biometric sample.

### Overview of Authentication of a User

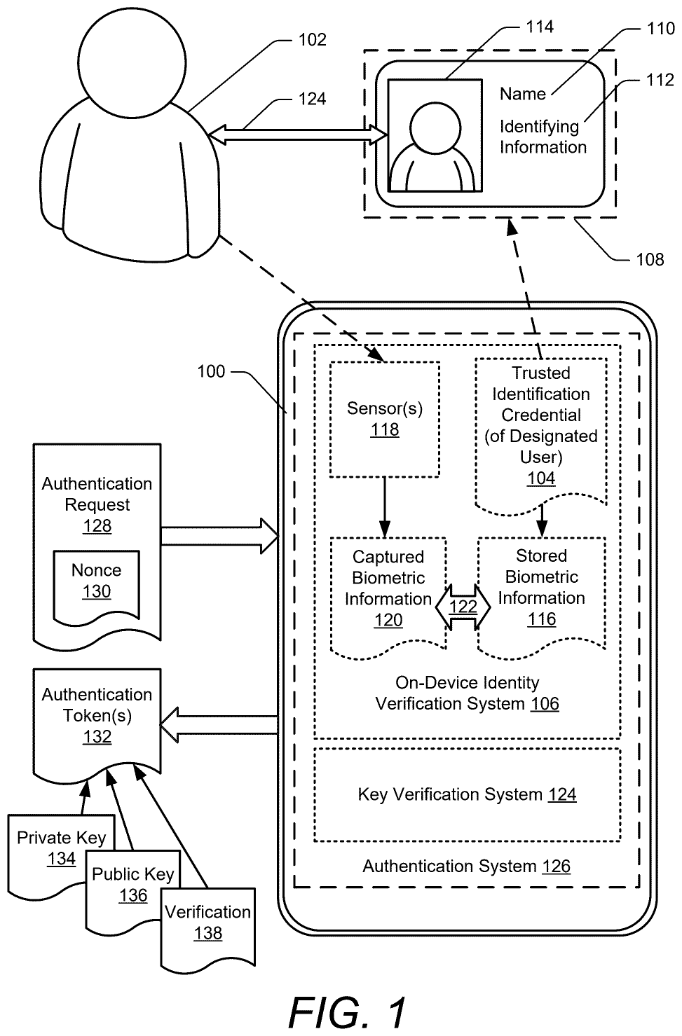

FIG. 1 shows a block diagram of a communications device 100 configured to perform a method for authenticating that a current user 102 of the communications device 100 matches a trusted identification credential 104 via on-device identity verification (ODIV). As further described below, the on-device identity verification is part of a unified authentication process that involves transmission of the trusted identification credential, a request for authentication including a nonce, and issuance of an authentication token that includes the nonce and an indicator that the on-device identity verification was successful.

The trusted identification credential 104 is a credential issued or assigned to a designated user of the communications device 100 that is stored in or is communicatively accessible to the communications device 100. It is appreciated that the communications device 100 may not be a single, physical device associated with the designated user, but may include a device that the designated user may be able to access a user account with which the trusted identification credential is associated.

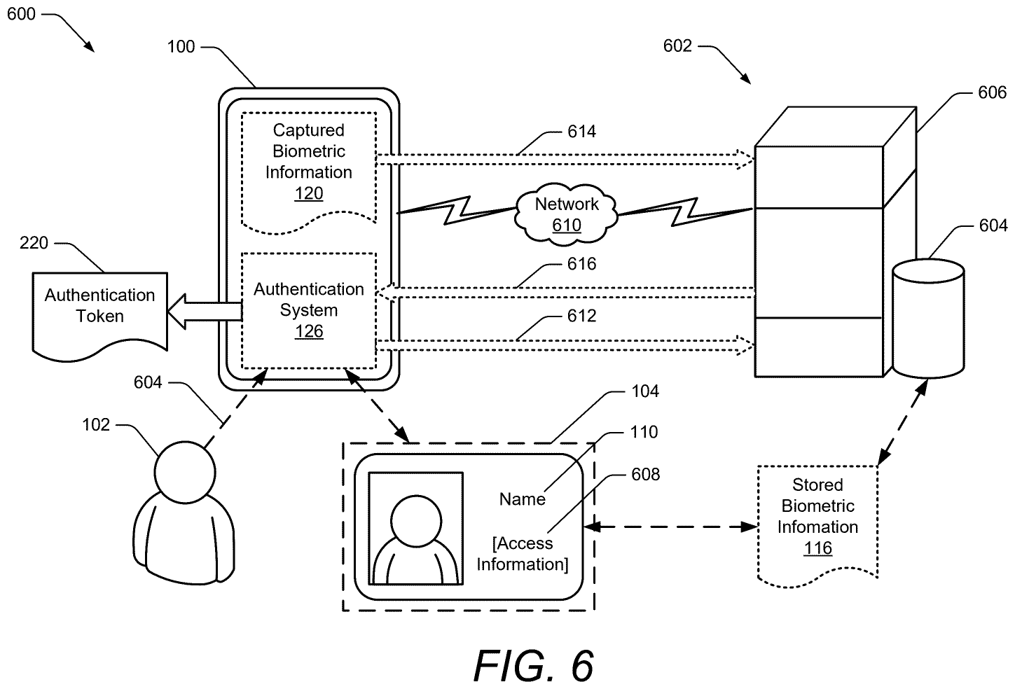

In aspects, the communications device 100 includes an on-device identity verification system 106 that accesses the trusted identification credential 104 of the designated user of the communications device 100. The communications device 100, independently or in cooperation with one or more other devices accessible via a communications network (see FIG. 6), authenticates that the current user 102 is the designated user to whom the trusted identification credential 104 was issued.

The trusted identification credential 104 may include a digital or digitized trusted identification credential 108 (represented by a dashed outline) derived from the identification credential 104 and being associated with biometric information about the designated user, as further described below. Like any trusted identification credential, the digital trusted identification credential may include information about the individual to whom it was issued such as the name 110 of the individual, additional identifying information 112, such as hair and/or eye color, height, age, license or other identification numbers, a home or office address, or other information. In addition, the digital trusted identification credential 108 also may include or be associated with biometric information 114 usable to confirm the identity of the individual presenting the digital trusted identification credential 108. In the example of FIG. 1, the biometric information 114 includes a photograph of the individual. The biometric information 114 constitutes stored biometric information 116 that may be stored in the communications device 100 or otherwise accessible to the communications device 100 to authenticate the identity of the current user 102 of the communications device 100.

To verify that the current user 102 of the communications device 100 is the designated user to whom the trusted identification credential 104 was issued, the communications device uses one or more sensors 118 incorporated into or otherwise associated with the communications device 100 to collect biometric information about the current user 102. In the present example, it is assumed that the sensor 118 is a camera or other imaging sensor that collects visual data about the current user 102, which is then stored as captured biometric information 120, as further described below. The on-device identity verification system 106 then performs a verification 122 of the captured biometric information 120 by, for example, analytically comparing the captured biometric information 120 with the stored biometric information 116. This is analogous to making a comparison 124 of the biometric information 114 of the trusted identification credential 108 with the discernible characteristics of the current user 102. In response to determining that the captured biometric information 120 sufficiently matches (i.e., by more than a threshold number of matching data points) the stored biometric information 116, the current user 102 may be authenticated as the designated user to whom the trusted identification credential 104 was issued.

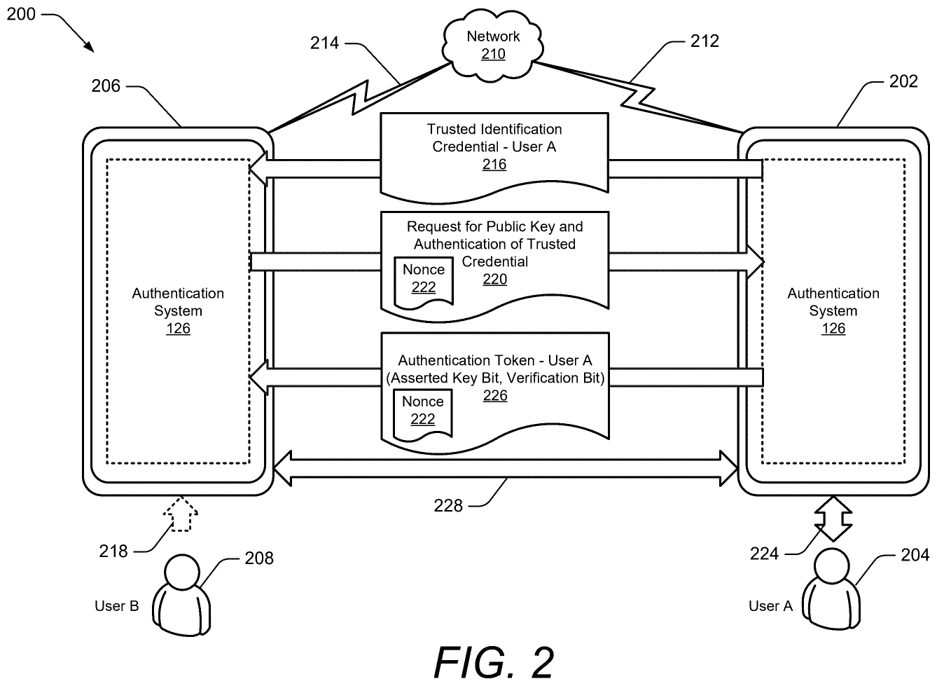

In aspects, the on-device identity verification system 106 works with a key verification system 124 as part of a unified authentication system 126. As further described with reference to FIG. 2, the authentication system 126 may receive an authentication request 128 from another user or another device (not shown in FIG. 1). The authentication request 128 may include a nonce 130 that includes a one-time code and is time-stamped so that it cannot be intercepted and used in a later attempt to fool a user of the communications device 100 such as a reply attack or a man-in-the-middle (MitM) attack. To respond to the authentication request 128, the authentication system 126 may generate an authentication token 132 that is cryptographically signed, such as with a private key 134 associated with the designated user, and that includes the nonce 130, a public key 136 of the designated user of the communications device 100, and a verification 138 that the current user 102 has been matched to the stored biometric information 116 of the designated user, as further described below. The other party, upon receiving the authentication token 126, may then trust that they are in communication with the desired person. Upon being authenticated as the designated user of the communication device 100, the current user 102 may be permitted to use the communications device 100 to engage in various transactions, such as participating in secured communications.

It will be appreciated that, while an exchange of keys may substantiate to others participating in secured communication that the communications device 100 is associated with a designated user to whom the keys are assigned, the on-device identity verification system 106 authenticates that the current user 102 is the designated user of the communications device 100 and not some third party that has been able to gain access to the communications device 100.

FIG. 2 shows establishment of a secured communication 200 conducted between a first communications device 202 used by user A 204 and a second communications device 206 used by user B 208. The communications devices 202 and 206 communicate over a network 210 to which each of the communications devices 202 and 206 are connected by communications links 212 and 214, respectively, that may represent Wi-Fi connections, mobile wireless communications, or other links. Each of the communications devices 202 and 206 includes the authentication system 126 of FIG. 1.

In aspects, the secured communication may include end-to-end encrypted (E2EE) messaging using, for example, the Google Messages application used between devices on the Android operating system. The secured connection may be established according to W3C Digital Credentials API (Web) and Credman (Android/Wallet) standards and using the Android System Key Verifier (KV). It is appreciated that the Android Key Verification performs hardware-backed key attestation to attest to a public key exchanged in establishing the secured communication described below.

To establish the secured communication, user A 204 may transmit to user B 208 a derived identification credential that represents a digital form of a trusted identification credential 216, such as a World Wide Web Consortium (W3C) or Internet Engineering Task Force (IETF) Selective Disclosure JavaScript Object Notation Web Token (SD-JWT) verifiable credentials. These digitally-signed credentials are tamper-resistant and readily verifiable, and may be exchanged, for example, according to the Open Identification for Verifiable Presentations (OpenID4VP) standards. A mobile driver's license conforming to the International Organization for Standardization (ISO) 18013-5 is one example of a trusted identification credential 216. However, even though user A 204 is in possession of the trusted identification credential, user B 208 cannot be sure that user A 204 actually is the person to whom the trusted identification credential 216 was issued. Thus, automatically upon receiving the trusted identification credential 216 or in response to a request 218 from user B 208, the authentication system 126 of the communications device 206 issues a request for public key and authentication of the trusted identification credential 220, that might include a request in Android Key Verification, such as “contactVerify.” In aspects, the request 220 includes a nonce 222 including a one-time code and a timestamp, as previously described.

Upon receiving the request 220, the authentication system 126 may engage the on-device identity verification system 106 to collect captured biometric information 120, such as visual data of the face of user A 204 and make a comparison (represented by the double-ended arrow 224) with the stored biometric information 116 associated with the trusted identification credential 216. If the on-device identity verification system 106 determines that the current user, user A 204, is the designated user to whom the trusted identification credential 216 was issued, the authentication system 126 of the communications device 202 issues an authentication token 226. The authentication token 226, which may include an asserted key bit from a public key attested by Android Key Verification, a verification bit, such as a signed boolean, that signifies that the on-device identity verification system 106 determined that user A 204 matches the biometric information associated with the trusted verification credential 216, and the nonce 222 in a request in Android Key Verification, such as “contactVerifyResponse.” Then, the authentication systems 126 of the communications devices 202 and 206 may then enter into a secured communication 228, such as by using the Google Messages application. The biometric verification resulting from the on-device identity verification is thus bound with the key verification process to provide authentication of the public key, authenticating that the first communications device 206 is that of the designated user of the first communications device 202 and that the current user, user A 204, is the designated user.

### Examples of Implementing Trusted Identification Credentials

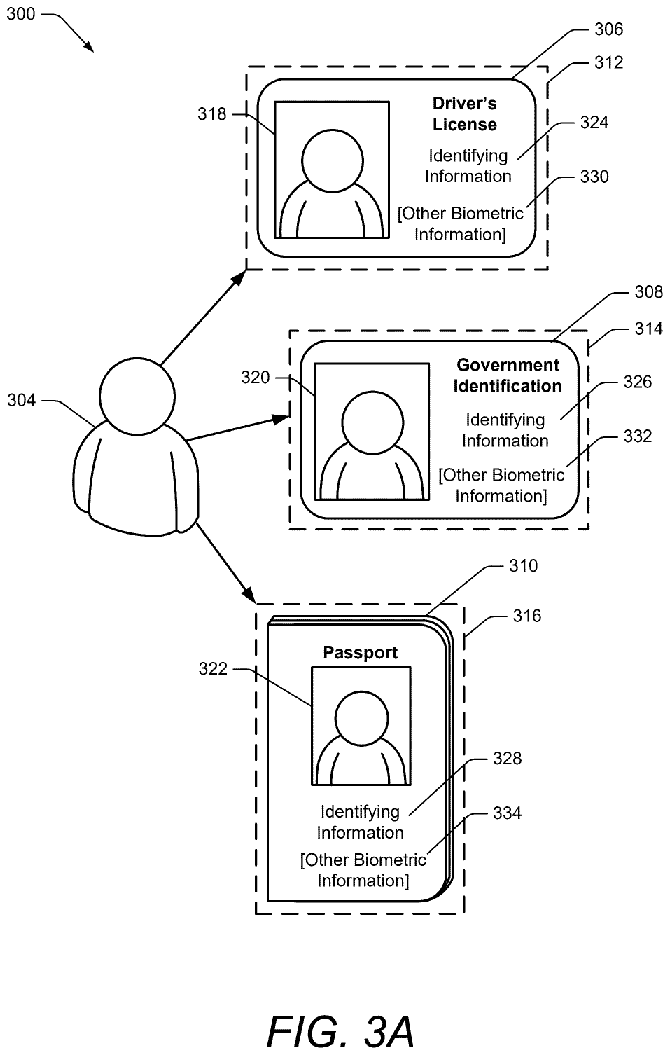

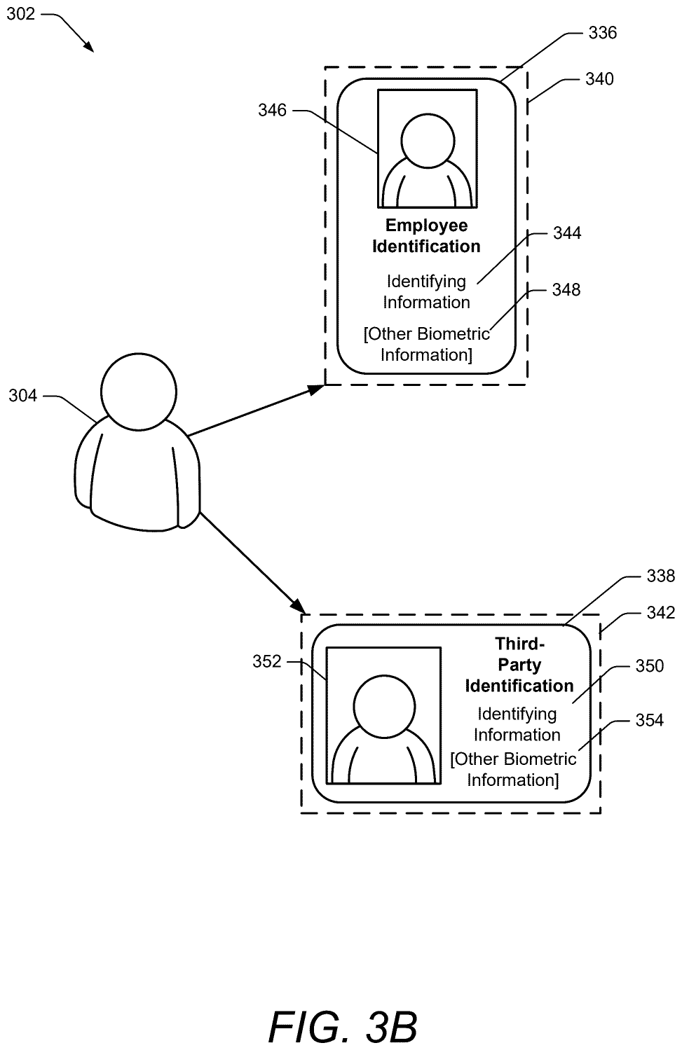

FIGS. 3A and 3B are schematic diagrams of various forms of government-issued trusted identification credentials 300 or privately-issued trusted identification credentials 302, respectively, that may be issued to an individual 304 for use with the on-device identity verification system 106 (see FIG. 1).

Each type of the government-issued trusted identification credentials 300 is visually represented in FIG. 3A in its familiar, physical form for the sake of description, including a driver's license 306, a government identification card 308, and a passport 310. However, each of the driver's license 306, a government identification card 308, and a passport 310 is outlined with a dashed outline 312, 314, and 316, respectively, to signify that each of the trusted identification credentials represent a derived identification credential in a digital or digitized form, such as a mobile driver's license is derived from or based on a conventional driver's license and associated with biometric information, as further described below. The derived identification credential is stored in or otherwise accessible to the communications device employed by the individual 304.

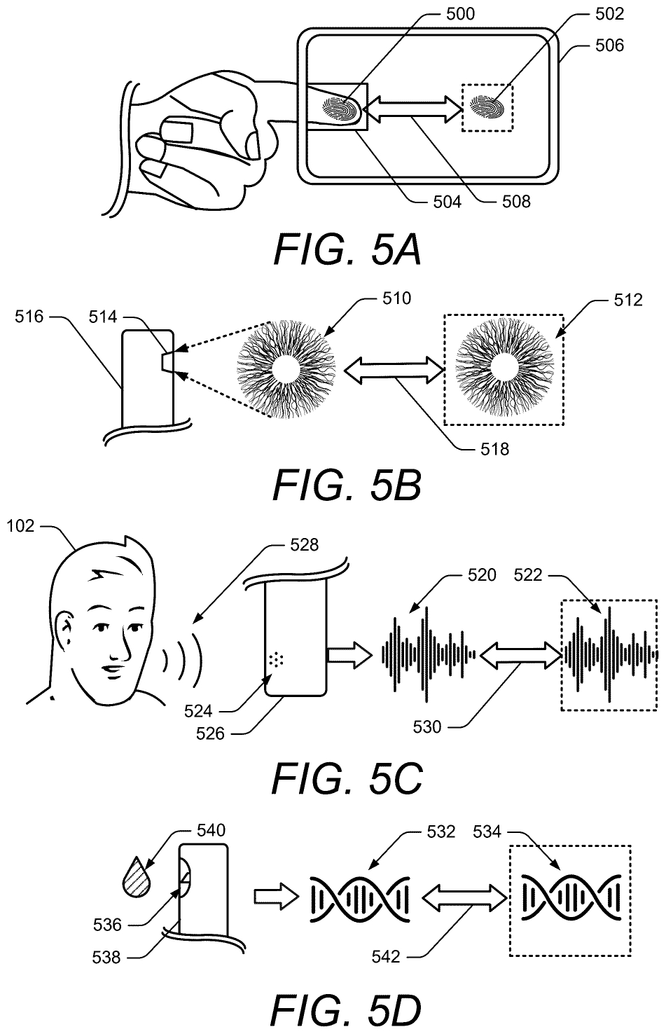

As previously described, each of the driver's license 306, a government identification card 308, and a passport 310 includes or is otherwise associated with stored biometric information 116 that may be used to verify that captured biometric information 120 collected from the current user 102 sufficiently matches the stored biometric information 116 of the designated user to authenticate the current user 102 (see FIG. 1). Each of the driver's license 306, a government identification card 308, and a passport 310 may include a photograph 318, 320, and 322, respectively, of the individual to whom the respective government-issued trusted identification credential 306, 308, and 310 was issued. The photographs 318, 320, and 322 may constitute stored biometric information 116 to be used to potentially authenticate the individual 304. The government-issued trusted identification credentials 300 also may be associated with various identifying information 324, 326, and 328 associated with the individual 304. Also, in addition to or instead of the photographs 318, 320, and 322, the respective government-issued trusted identification credentials 306, 308, and 310 may be associated with other biometric information 330, 332, and 334 associated with the individual 304, as further described below. As also described further below with reference to FIGS. 5A through 5D, like the photographs 318, 320, and 322, the other biometric information 330, 332, and 334 may include visual or visually-verifiable information such as fingerprints, retinal patterns, etc., or other verifiable biometric information.

The government-issued trusted identification credentials 300 are generally recognized as reliable because they are issued by the government based on the individual 304 presenting themself and/or other trusted documentation to the satisfaction of the issuing agency. A driver's license 306 is a credential held by most adults. A driver's license 306 is widely recognized because a state agency issues the driver's license 306 only when the individual appears in person with multiple forms of documentation, such as a birth certificate, Social Security card, or other information that demonstrates that the individual is who they say they are and includes or substantiates identifying information 322, such as physical characteristics, included on the driver's license 306. Similarly, a government identification card 308 may be issued to individuals who are not eligible to drive or do not seek to drive. Like the driver's license, a state agency issues the government identification card 308 only when the individual appears in person with multiple forms of documentation, such as a birth certificate, Social Security card, or other information that demonstrates that the individual is who they say they are and includes or substantiates identifying information 326, such as physical characteristics, included on the government identification card 308. Likewise, a passport 310 may be issued by a federal government only when the individual appears in person with multiple forms of documentation, such as a birth certificate, Social Security card, or other information that demonstrates that the individual 304 is who they say they are and includes or substantiates identifying information 328, such as physical characteristics, similar to those included on the driver's license 306 and/or the government identification card 308.

The photographs 318, 320, and 322, and/or other biometric information 330, 332, and 334 associated with the respective government-issued identification credentials 306, 308, and 310, are collected by the government agency issuing the respective government-issued identification credentials 306, 308, and 310. Accordingly, the photographs 318, 320, and 322, and/or other biometric information 330, 332, and 334 are considered to be reliable verification of the identity of the individual 304.

Referring to FIG. 3B, instead of a government-issued credential, a trusted identification credential may include one of a number of privately-issued trusted identification credentials 302. Privately-issued trusted identification credentials 302 may include an employee identification credential 336. The employee identification credential 336 may include an employee identification card, an employee security badge, or a similar credential issued to the individual 304 by an employer. It is appreciated that, if an individual 304 works for a government, the employee identification credential 336 may also represent a government-issued identification credential, albeit not one that may be available to the general public such as a driver's license 306, a government identification card 308, or a passport 310. The privately-issued trusted identification credentials 302 also may include a third-party identification credential 338 issued by a financial institution or other private entity, such as an ID Pass, that may be storable in a digital wallet.

The privately-issued trusted identification credentials 302, like the government-issued trusted identification credentials 300, are each depicted in a familiar, tangible form. However, each of the respective privately-issued trusted identification credentials 336 and 338 is outlined with a dashed outline 340 and 342 to signify that each of the trusted identification credentials represent a derived identification credential in a digital or digitized form that is associated with biometric information and stored in or otherwise accessible to the communications device employed by the individual 304, as further described below.

The employee identification credential 336 may be issued by an employer upon presenting themselves and various forms of documentation that satisfy the employer and substantiate identifying information 344 that is also included in the employee identification credential 336. At the time of issuance, the employer also may collect a photograph 346 and may collect other biometric information 348 that may be used as the stored biometric information 116 (see FIG. 1), such as visual or visually-verifiable information or other biometric information as described with reference to FIGS. 5A through 5D. Because the employee identification credential 336 is issued by the employer with the photograph 346 and/or other biometric information 352 collected by the employer, the employee identification credential 336 may be sufficient proof of identity for intra-enterprise communications or other intra-enterprise matters.

Analogously, the third-party identification credential 338 issued by some other private entity identification credential 336 may be issued by the third party when the individual 104 presents identifying information 350 that is also included in the third-party identification credential 338. At the time of issuance, the third party also may collect a photograph 352 and may collect other biometric information 354, such as visual or visually-verifiable information or other biometric information that may be used as the stored biometric information 116 (see FIG. 1). The third-party identification credential 338 may be sufficient proof of identity for individuals who trust the third party.

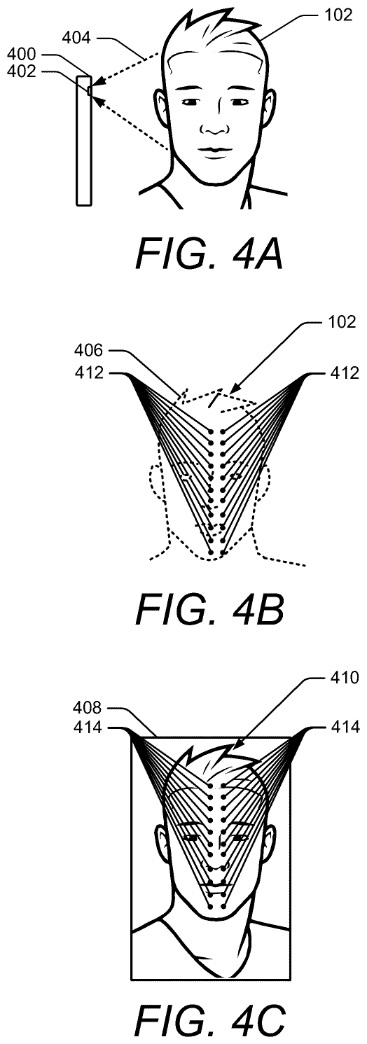

Referring to FIGS. 4A through 4C, in the example of using photographs 318, 320, or 322 included in government-issued trusted identification credentials 300 or photographs 346 and 352 included in privately-issued trusted identification credentials 302 as the stored biometric information 116 (FIG. 1), the identity of the current user 102 may be verified using facial recognition techniques. FIG. 4A shows a communication device, such as a mobile telephone 400, via its camera or other image sensor 402, collecting image data 404 (represented by dashed arrows) of the user 102.

Referring to FIG. 4B, a captured image 406 (represented in dotted lines to distinguish it from a stored image 408 of the current user 102 of FIG. 4C) representing the captured biometric information 120 (see FIG. 1) yielded from the image data 404 will be compared with the stored image 408 of the designated user 410 that constitutes the stored biometric information 116 (see FIG. 1). For example, by comparing a number of points 412 in the captured image 406 with a number of corresponding points 414 at corresponding positions in the stored image 408, it is determined if the captured image 406 constituting the captured biometric information 120 sufficiently matches the stored image 408 constituting the stored biometric information 116 to verify that the captured biometric information 120 indicates that the current user 402 is the designated user 410. If the captured image 406 of the current user 102 sufficiently matches the stored image 408 of the designated user 410, the current user 102 is authenticated as the designated user 410. Then, for example, upon authenticating the current user 102 as the designated user 410, as described with reference to FIGS. 1 and 2, the authentication token 126 may be generated to authenticate that the current user 102 is the designated user 410.

As previously described with reference to FIGS. 3A and 3B, in addition to or instead of using photographs 318, 320, or 322 included in government-issued trusted identification credentials 300 or photographs 346 and 352 included in privately-issued trusted identification credentials 302 as the stored biometric information 116, verification of identity of a current user may be performed using other biometric information 330, 332, 334, 348, or 354 using processes other than facial recognition. Just as a person's face may include unique features that enable a person's identity to be determined or verified from those features, the other biometric information 330, 332, 334, 348, or 354 includes attributes unique to the individual that similarly enable a person's identity to be determined or verified.

As previously described, biometric information may include visual or visually-verifiable information other than a photograph, such as fingerprint data or retinal pattern data described in FIGS. 5A and 5B. Referring specifically to FIG. 5A, captured biometric information may be in the form of captured fingerprint data 500 collected from a current user 102 (see FIGS. 1 and 2) and stored biometric information may be in the form of previously stored fingerprint data 502 of the designated user 202 (see FIG. 2) that is outlined with a dotted outline to distinguish it from the captured fingerprint data 500. It is appreciated that fingerprints, in their pattern of loops, whorls, and arches, are unique to each person. The captured fingerprint data 500 representing one or more fingerprints of the current user 102 may be collected by an in-display or under-display reader 504 or other imaging device incorporated in a communications device 506. Verification of the captured fingerprint data 500 may be performed by comparing the captured fingerprint data 500 of the current user 102 (the comparison represented by a double-headed arrow 508) with the stored fingerprint data 502 of the designated user 202. If the comparison 508 indicates that the captured fingerprint data 500 of the current user 102 sufficiently matches the stored fingerprint data 502 of the designated user 202, the current user 102 of the communications device 506 may be authenticated as the designated user 202 of the communications device 506.

Referring to FIG. 5B, captured biometric information may be in the form of captured retinal pattern data 510 collected from a current user 102 (see FIGS. 1 and 2) and stored biometric information may be in the form of previously stored retinal pattern data 512 of the designated user 202 (see FIG. 2) that is outlined with a dotted outline to distinguish it from the captured retinal pattern data 510. It is appreciated that retinal patterns, in their pattern of individualized network of blood vessels within the retina, are unique to each person. The captured retinal pattern data 510 may be collected by a camera or other imaging device 514 incorporated in a communications device 516. Verification of the captured retinal pattern data 510 may be performed by comparing the captured fingerprint data 510 of the current user 102 (the comparison represented by a double-headed arrow 518) with the stored retinal pattern data 512 of the designated user 202. If the comparison 518 indicates that the captured retinal pattern data 510 of the current user 102 sufficiently matches the stored retinal pattern data 512 of the designated user 202, the current user 102 of the communications device 516 may be authenticated as the designated user 202 of the communications device 516.

Referring to FIG. 5C, captured biometric information may be in the form of captured voice pattern data 520 collected from a current user 102 and stored biometric information may be in the form of previously stored voice pattern data 522 of the designated user 202 (see FIG. 2) that is outlined with a dotted outline to distinguish it from the captured voice pattern data 520. It is appreciated that voice patterns, based on size, shape, and/or physical attributes of an individual's vocal chords, combined with learned articulation behaviors, are unique to each person. The captured voice pattern data 520 may be collected by a microphone or other sound detecting device 524 incorporated in a communications device 526 from a speech sample 528 provided by the current user 102. Verification of the captured voice pattern data 520 may be performed by comparing the captured voice pattern data 520 of the current user 102 (the comparison represented by a double-headed arrow 530) with the stored voice pattern data 522 of the designated user 202. If the comparison 530 indicates that the captured voice pattern data 520 of the current user 102 sufficiently matches the stored voice pattern data 522 of the designated user 202, the current user 102 of the communications device 526 may be authenticated as the designated user 202 of the communications device 526.

Referring to FIG. 5D, captured biometric information may be in the form of a captured biological signature data 532 collected from a current user 102 (see FIGS. 1 and 2) and stored biometric information may be in the form of previously stored biological signature data 534 of the designated user 202 (see FIG. 2) that is outlined with a dotted outline to distinguish it from the captured biological signature data 532. It is appreciated that biological identifiers are based on an individual's genetic makeup and are unique to each person. The captured voice pattern data 532 may be collected by a sampling device 536 incorporated in a communications device 538 from a sample 540, such as a biological fluid sample, provided by the current user 102. Verification of the captured biological signature data 532 may be performed by comparing the captured biological signature data 534 of the current user 102 (the comparison represented by a double-headed arrow 542) with the stored biological signature data 534 of the designated user 202. If the comparison 542 indicates that the captured biological signature data 532 of the current user 102 sufficiently matches the stored voice biological signature data 534 of the designated user 202, the current user 102 of the communications device 538 may be authenticated as the designated user 202 of the communications device 538.

Whether performing user authentication using facial recognition as described with reference to FIGS. 4A through 4C or authentication using other biometric information as described with reference to FIGS. 5A through 5D, accessing and/or verifying the captured biometric 120 against the stored information 116 may be performed solely on the communications device or in concert with one or more additional devices. FIG. 6 shows a system 600 in which the communications device 100 engaged by the current user 102 interacts with a remote device 602 as part of the process of verifying the captured biometric 120 data against the stored biometric information 116 to authenticate the current user. As previously described with reference to FIGS. 1, 2, 4A, and 5A-5D, the captured biometric information 120 is collected by the on-device identity verification system 106 at the communications device 100 using a collection process 604 like those previously described. As also previously described, the communications device 100 stores or has access to the trusted identification credential 104 that includes or provides access to the stored biometric information 116.

In aspects, verification of the current user 102 by performing a comparison of the captured biometric information 120 with the stored biometric information 116 is performed at the communications device 100 by performing facial recognition, fingerprint recognition, or one of the other described verification processes described with reference to FIGS. 4B through 5D at the communications device. It will be appreciated that facial recognition and fingerprint recognition are commonly used to unlock communications devices such as mobile telephones and portable computers.

In other aspects, the communications device 100 may initiate the verification of the current user 102 in cooperation with one or more remote devices, such as the remote device 602. The communications device 100 is used to collect the captured biometric information 120 using one of the processes previously described. However, in some aspects, the stored biometric information 116 may be stored at the remote device 602, such as in remote storage 604 accessible by a server or another processing device 606. The trusted identification credential 104, rather than storing the stored biometric information 116, may include access information 608, such as an alphanumeric code, that enables the communications device 100 to identify or access the stored biometric information 116 at the remote device 602.

For example, the access information 608 may be used by the on-device identity verification system 106 to communicate over a network 610 with the remote device 602 from which the stored biometric information 116 may be accessed. In aspects, the stored biometric information 116 may be retrieved from the remote device 602 by the communications device 100 (as represented by dotted arrow 612), where the captured biometric information 120 is compared with the stored biometric information 116. In other aspects, the communications device 100 may initiate the verification of the captured biometric information 120 by transmitting the captured biometric information 120 over the network 610 to the remote device 602 (as represented by dotted arrow 614) to enable the processing device 606 at the remote device 602 to perform the verification. In other aspects, the verification may be collaborative with both the communications device 100 providing the captured biometric information 120 to the remote device 602 and the remote device 602 providing the stored biometric information 116 to the communications device 100. In a collaborative arrangement, duplicative verification may provide greater verification reliability for some or all applications. The remote device 602 may provide higher computing power that may allow for more granular comparisons of images or other biometric information. When some or all of the verification is performed at the remote device 602, results are communicated via the network 610 to the communications device 100 (as represented by dotted arrow 616).

Regardless of whether the verification is completed at the communications device 100 and/or at the remote device 602, in response to the current user 102 being is verified as the designated user of the communications device 100, the authentication token 220 is generated, for example, to authorize the current user 102 to participate in a secured communication with other users. In aspects, the authorization token 220 is generated by the on-device identity verification system 106 for transmission to the second device 204 of the second user 202 (see FIG. 2) to authenticate to the second user 202 that the current user 102 is the designated user of the communications device 100.

### Example Systems Employing on-Device Identity Verification

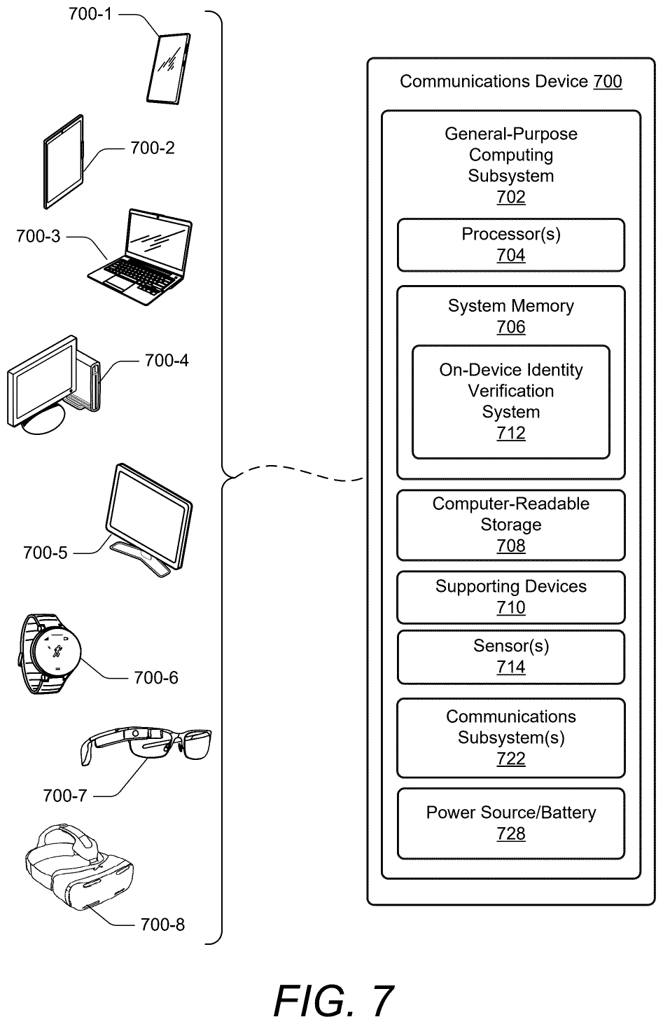

Referring to FIG. 7, a communications device 700 that includes an on-device identity verification system 106 (see FIGS. 1 and 6) may be implemented as any suitable device, some of which are illustrated as a smartphone 700-1, a tablet computer 700-2, a laptop computer 700-3, a gaming console 700-4, a desktop computer 700-5, a wearable computing device 700-6 (e.g., a smartwatch), augmented reality (AR) glasses 700-7, or virtual reality goggles or glasses 700-8. Although not shown, the communications device 700 may also be implemented in other devices that may be used for communications, such as a smart-home or smart-office control panel or control console, an on-board control and communications system of an automobile or another vehicle, a personal media device, a network-connected home appliance, an Internet-of-Things (IoT) device, and/or other types of electronic devices. The communications device 700 may provide other functions or include components or interfaces omitted from FIG. 7 for the sake of clarity or visual brevity.

The communications device 700 may include a general-purpose computing subsystem 702 including one or more processors 704, a system memory 706 (including random access memory, read only memory, and other memory devices), computer-readable storage 708, and supporting devices 710 that interconnect the elements of the general-purpose computing subsystem 702 and that provide communications with other elements of the communications device 700. In aspects, an on-device identity verification system 712 may be implemented by computer-executable instructions that may be retrieved into and executed from the system memory 706 by the one or more processors 704 in communications with other aspects of the communications device 700.

As previously described with reference to FIGS. 1, 4A, and 5A through 5D, the general-purpose computing subsystem 702 of the communications device 700 may include one or more sensors 714, such as one or more cameras or imaging devices, a microphone, and other sensors that may be used to collect captured biometric information. As also previously described, the general-purpose computer subsystem 702 of the communications device 700 may include one or more communications subsystems 716 that enable the communications device 700 to communicate with other communications devices, such as the second communications device 200 of FIG. 2 or the remote device 602 of FIG. 6. The general-purpose computing subsystem 702 of the communications device 700 also may include a power source and/or battery 718 that powers the communications device 700.

### Example Method of Performing on-Device Identity Verification

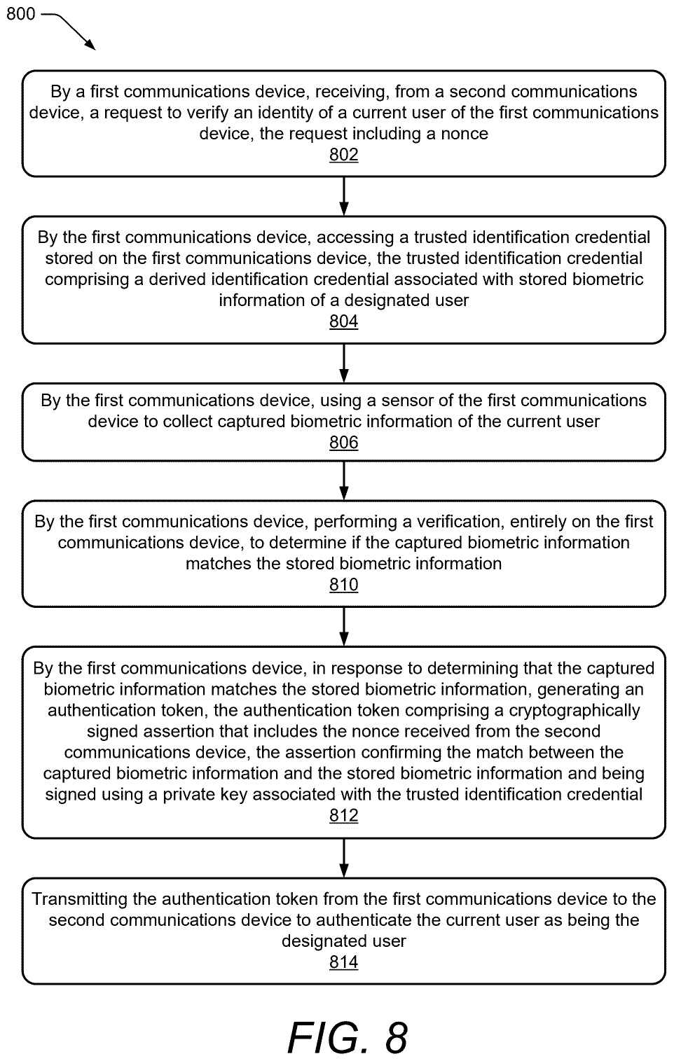

FIG. 8 is a flow diagram of an example method 800 of performing on-device identity verification to complete a unified exchange of key verification and identity verification to authenticate a user of a first communications device to a second communications device. At 802, a request to verify an identity of a current user of the first communications device is received by the first communications device from a second device, the request including a nonce, as previously described with reference to FIG. 2. At 804, a trusted identification credential stored on the first communications device is accessed by the first communications device, the trusted identification credential comprising a derived identification credential associated with stored biometric information of a designated user, as previously described with reference to FIGS. 2 through 3B. At 806, using a sensor of the first communications device, captured biometric information of the current user is collected by the first communications device, as previously described with reference to FIGS. 4A and 5A through 5D. At 808, verification is performed by the first communications device, to determine if the captured biometric information matches the stored biometric information, as described with reference to FIGS. 4B, 4C, and 5A through 5D.

At 810, in response to determining that the captured biometric information matches the stored biometric information, an authentication token is generated, the authentication token comprising a cryptographically signed assertion that includes the nonce received from the second communications device, an assertion confirming the match between the captured biometric information and the stored biometric information, and signed using a private key associated with the trusted identification credential. At 812, the authentication token is transmitted from the first communications device to the second communications device to authenticate the current user as being the designated user.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although implementations of systems and techniques for authenticating a user by matching a trusted identification credential with on-device identity verification have been described in language specific to certain features and/or methods, the subject of the appended claims is not necessarily limited to the specific features or methods described. Rather, the specific features and methods are disclosed as example implementations of systems and techniques for authenticating a user by matching a trusted identification credential with on-device identity verification.

What is claimed is:

1. A method for authenticating a user of a first communications device to a second communications device, the method comprising:
by the first communications device:
receiving, from the second communications device, a request to verify an identity of a current user of the first communications device, the request including a nonce;
accessing a trusted identification credential stored on the first communications device, the trusted identification credential comprising a derived identification credential associated with stored biometric information of a designated user;
using a sensor of the first communications device to collect captured biometric information of the current user;
performing a verification, entirely on the first communications device, to determine if the captured biometric information matches the stored biometric information; and
in response to determining that the captured biometric information matches the stored biometric information:
generating an authentication token, the authentication token comprising a cryptographically signed assertion that includes the nonce received from the second communications device, the assertion confirming the match between the captured biometric information and the stored biometric information and being signed using a private key associated with the trusted identification credential; and
transmitting the authentication token to the second communications device to authenticate the current user as being the designated user.

2. The method of claim 1, wherein the derived identification credential includes:
a government-issued identification credential;
a privately-sourced identification credential.

3. The method of claim 2, wherein the government-issued identification credential includes one or more of:
a government identification card;
a driver's license issued by a government; and
a passport issued by a government.

4. The method of claim 2, wherein the privately-sourced identification credential includes one or more of:
an employee government identification card or badge; and
a third-party-issued identification credential.

5. The method of claim 1, wherein the derived identification credential is stored in the communications device of the designated user.

6. The method of claim 3, wherein the stored biometric information is stored in the communications device or is accessed from a remote data server.

7. The method of claim 1, wherein the stored biometric information associated with the trusted identification credential includes one or more of:
an image of the designated user that is matchable to visual information of the current user capturable by an imaging sensor associated with the communications device;
a voice pattern of the designated user that is matchable to a recorded vocal pattern of the current user capturable by a microphone associated with the communications device; and
a biological signature of the designated user that is matchable to a sample provided by the current user capturable by a sample sensor associated with the communications device.

8. The method of claim 7, wherein the visual data includes a captured image of the current user's face that is matchable to facial data of the designated user in the stored biometric information.

9. The method of claim 7, wherein the visual data includes a captured image of one or more of the current user's fingerprints that is matchable to fingerprint information of the designated user included in the stored biometric information.

10. The method of claim 7, wherein the visual data includes a captured image of the current user's retinal pattern that is matchable to retinal pattern information of the designated user included in the stored biometric information.

11. The method of claim 7, wherein the imaging sensor includes a camera.
